(19) United States
(12) Patent Application Publication
(10) Pub. No.: US 2015/0117399 A1
(43) Pub. Date: Apr. 30, 2015

(54) BATON HANDOVER WITH RECEIVE DIVERSITY IN TD-SCDMA

(71) Applicant: QUALCOMM Incorporated, San Diego, CA (US)

(72) Inventors: Ming YANG, San Diego, CA (US); Tom CHIN, San Diego, CA (US); Guangming SHI, San Diego, CA (US)

(73) Assignee: QUALCOMM Incorporated, San Diego, CA (US)

(21) Appl. No.: 14/066,618

(22) Filed: Oct. 29, 2013

(51) Int. Cl. H04W 36/30

(52) U.S. Cl. CPC H04W 36/30; H04W 36/08
USPC 370/331

(57) ABSTRACT

In baton handover in TD-SCDMA communications, a user equipment (UE) may make use of multiple receivers in a receive diversity configuration to reduce call drops during baton handover. Following uplink handover, the UE may tune a first receiver to a target cell while maintaining a second receiver tuned to the source cell. If the UE measures a signal quality of the target cell greater than a signal quality of the source cell the UE tunes the second receiver to the target cell and complete the handover. If the UE measures a signal quality of the source cell greater than a signal quality of the target cell, the UE may switch the first receiver and UL back to the source cell and terminate the handover. Thus the UE may avoid handover to a target cell with poor signal quality.

### BACKGROUND

1. Field

Aspects of the present disclosure relate generally to wireless communication systems, and more particularly, to avoiding call drop during baton handover in a TD-SCDMA network.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Packet Access (HSPA), which provides higher data transfer speeds and capacity to associated UMTS networks. HSPA is a collection of two mobile telephony protocols, High Speed Downlink Packet Access (HSDPA) and High Speed Uplink Packet Access (HSUPA), that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

Offered is a method for wireless communication. The method includes receiving a command to perform a baton handover from a source cell to a target cell. The method also includes performing a handover of uplink communications from the source cell to the target cell. The method further includes tuning a first downlink receiver to a working frequency of the target cell while maintaining a second downlink receiver with a working frequency of the source cell. The method still further includes comparing a first signal quality measured by the first receiver with a second signal quality measured by the second receiver.

Offered is an apparatus for wireless communication. The apparatus includes means for receiving a command to perform a baton handover from a source cell to a target cell. The apparatus also includes means for performing a handover of uplink communications from the source cell to the target cell. The apparatus further includes means for tuning a first downlink receiver to a working frequency of the target cell while maintaining a second downlink receiver with a working frequency of the source cell. The apparatus still further includes means for comparing a first signal quality measured by the first receiver with a second signal quality measured by the second receiver.

Offered is a computer program product for wireless communication in a wireless network. The computer program product includes a computer-readable medium having non-transitory program code recorded thereon. The program code includes program code to receive a command to perform a baton handover from a source cell to a target cell. The program code further also includes program code to perform a handover of uplink communications from the source cell to the target cell. The program code also includes program code to tune a first downlink receiver to a working frequency of the target cell while maintaining a second downlink receiver with a working frequency of the source cell. The program code still further includes program code to compare a first signal quality measured by the first receiver with a second signal quality measured by the second receiver.

Offered is an apparatus for wireless communication. The apparatus includes a memory and a processor(s) coupled to the memory. The processor(s) is configured to receive a command to perform a baton handover from a source cell to a target cell. The processor(s) is also configured to perform a handover of uplink communications from the source cell to the target cell. The processor(s) is further configured to tune a first downlink receiver to a working frequency of the target cell while maintaining a second downlink receiver with a working frequency of the source cell. The processor(s) is still further configured to compare a first signal quality measured by the first receiver with a second signal quality measured by the second receiver.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 illustrates an example of network coverage areas.

FIG. 5 illustrates a call flow for baton handover according to one aspect of the present disclosure.

FIG. 6 illustrates a method for improved baton handover according to one aspect of the present disclosure.

FIG. 7 is a diagram illustrating an example of a hardware implementation for an apparatus employing a processing system.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

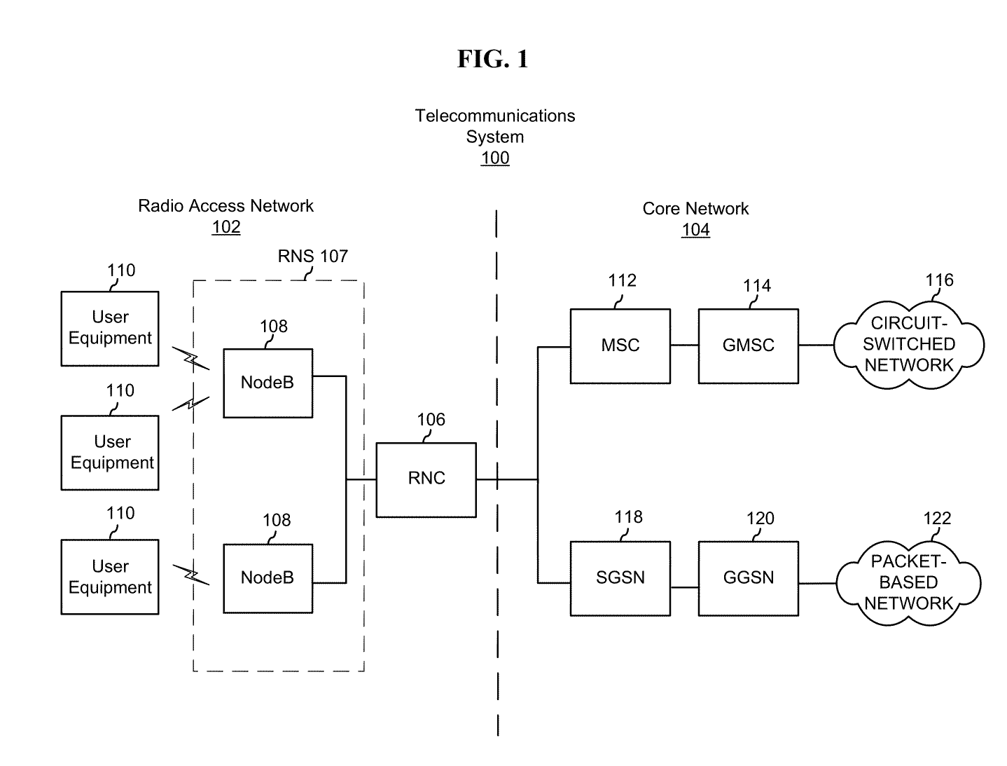

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

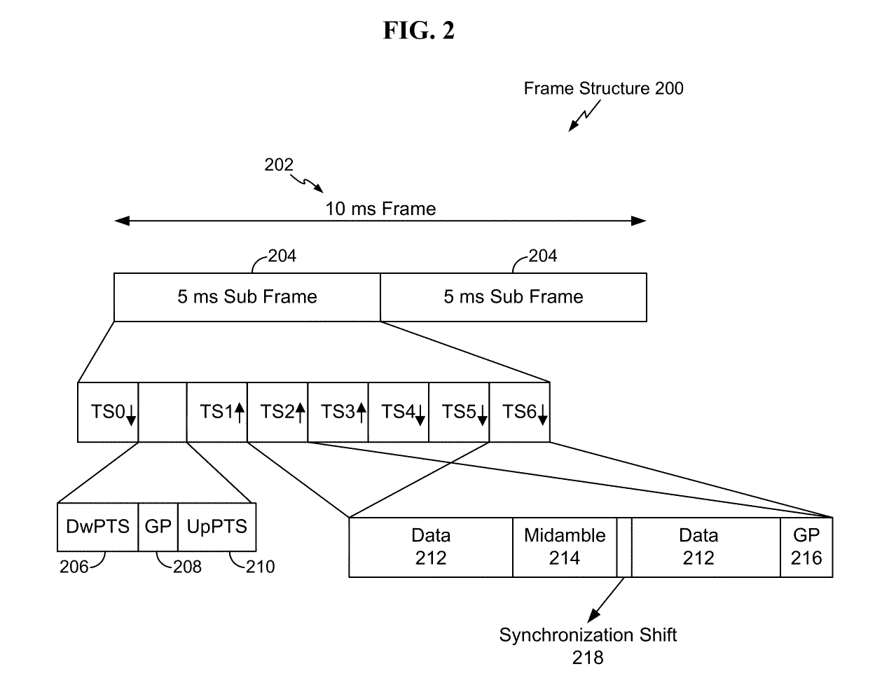

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including Synchronization Shift (SS) bits 218. Synchronization Shift bits 218 only appear in the second part of the data portion. The Synchronization Shift bits 218 immediately following the midamble can indicate three cases: decrease shift, increase shift, or do nothing in the upload transmit timing. The positions of the SS bits 218 are not generally used during uplink communications.

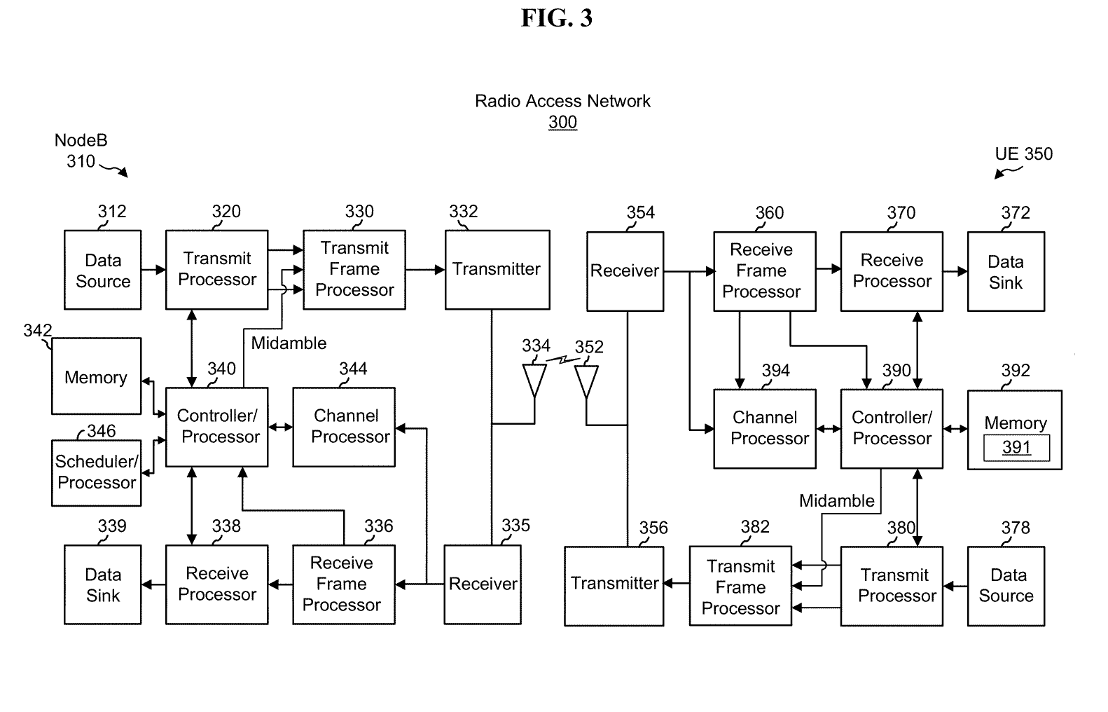

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the node B 310 and the UE 350, respectively. For example, the memory 392 of the UE 350 may store a baton handover module 391 which, when executed by the controller/processor 390, configures the UE 350 to, during baton handover, to handover one receiver to a target node B while maintaining a different receiver with a source node B. A scheduler/processor 346 at the node B 310 may be used to allocate resources to the UEs and schedule downlink and/or uplink transmissions for the UEs.

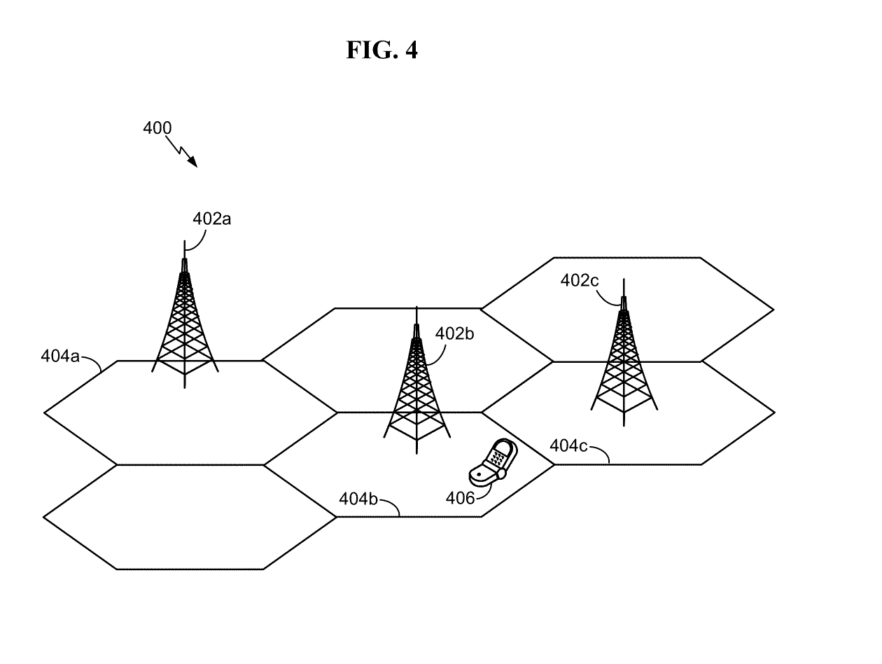

Some base stations in a network may cover only a portion of a geographical area. FIG. 4 illustrates coverage of a network, such as a TD-SCDMA network, as represented by individual base stations. A geographical area 400 may include multiple TD-SCDMA base stations, illustrated by towers 402a, 402b, and 402c, each serving their own respective geographic locations, illustrated by geographic cells 404a, 404b, and 404c, respectively. A user equipment (UE) 406 may move from one cell, such as cell 404a, to another cell, such as a cell 404b. The movement of the UE 406 may specify a handover or a cell reselection.

Baton Handover with Receive Diversity in TD-SCDMA

One feature of a Time Division-Synchronous Code Division Multiple Access (TD-SCDMA) network is the baton handover, which is widely deployed in certain networks. For a baton handover, upon receiving the handover command from the source node B, the UE first switches its uplink (UL) communications from the source node B to the target node B. The UE also sends the target node B a special burst which can help the target node B acquire the uplink and build downlink (DL) beamforming based on the uplink measurements. The DL beamforming will assist the communications from the target node B to the UE. Once UL communications have been handed over, then the UE switches its DL communications to the target node B.

During the transition period between UL handover and DL handover, the UE receives downlink communications from the source cell and sends uplink communications to the target cell. To manage this transition period, a handover timer begins upon handover of the UL communications. As presently indicated in the TD-SCDMA specification, this handover timer (also called the fixed downlink baton handover uplink to downlink switch timer) is 80 ms long. After this handover timer expires (i.e., after 80 ms), the UE switches the downlink communications to the target cell. Per certain specifications, during the transition period the network sends downlink data to both the source and target cell after sending the handover command to the UE. As the handover command may take some time to reach the UE, sending data for the UE to both the source and target node Bs makes it more likely that the data makes its way to the UE regardless of where the UE is in its handover procedure. After the network receives the indication that the handover procedure to the target cell is complete, the network proceeds to only send downlink data for the UE to the target cell. If, however, the network receives a handover failure indication from the source cell, the network proceeds to only send downlink data for the UE to the source cell as the UE never completed the handover procedure and has, for purposes of the network reverted to the source cell.

TD-SCDMA handover trigger is based on a primary frequency Primary Common Control Physical Channel (PCCPCH) received signal code power (RSCP) measurement of source and the target cell. The PCCPCH RSCP is mainly determined by path loss, i.e., the distance between the node B and the UE. During handover, the UE may actually handover to any working frequency of the target cell. The working frequency of the target cell may be the primary frequency of the target cell, but may not necessarily be the primary frequency, and may not necessarily consider the traffic time slot signal-to-noise ratio (SNR)/signal-plus-interference-to-noise ratio (SINR) of the particular frequency. This behavior may result in the UE performing a baton handover to a target cell working frequency when the traffic time slots allocated to the working frequency have strong interference. During the handover transition, without closed loop power control and timing control to adapt to radio frequency (RF) variations, a data package may be lost during transition. If a UE attempts handover to a target frequency with poor performance, handover failure and/or call drop may result.

To address this problem, and to reduce the number of call drops, proposed is a new scheme for incorporating UE receiver diversity into improved baton handover. Receiver diversity is when a UE has more than one receiver and is therefore capable of simultaneously tuning each receiver differently. The new proposal is discussed below.

A UE receives a handover command including an activation time to begin baton handover. When the activation time arrives, the UE commences baton handover by commencing UL handover. The UE then proceeds with DL handover as follows. The UE switches a first receiver of the UE to the target cell while maintaining a second receiver of the UE connected to the source cell. The UE then compares the signal quality of the target cell (as determined by the signal received by the first receiver) to the signal quality of the source cell (as determined by the signal received by the second receiver). The signal quality may be measured in SNR, SINR, RSCP, or other metric. If the signal quality of the target cell is better than the signal quality of the source cell then the UE switches its second receiver to the target cell or otherwise disconnects from the source cell. This comparison and switch of the second receiver may occur regardless of the status of the handover timer. Thus, if the UE completes its comparison and transition before the handover timer expires, the UE may complete the baton handover early. Similarly, if the UE has not completed the comparison and transition before the handover timer, the UE may complete the baton handover late. If the signal quality comparison results in the second receiver (still connected to the source cell) having a better signal quality than the first receiver (connected to the target cell), then the UE may switch its first receiver back to the source cell as well as switching its UL communications (i.e., its transmitters) back to the source cell and send a handover failure indication to the network. Thus, if the UE hands over to a target signal with poor performance, instead of continuing the handover procedure and risking handover failure/call drop, the UE will cancel the handover procedure, indicate handover failure to the network, and revert its communications back to the source cell, thus potentially reducing the likelihood of a dropped call.

If the UE is involved in a data call, during the baton handover instead of sending regular data, the regular data may be buffered and send instead a special burst (SB) is transmitted during baton handover. Communication of normal data is only resumed once the handover process is complete (resulting in either a good connection with the target cell or resumed communications with the source cell). In this manner data loss may be avoided should the baton handover prove unsuccessful.

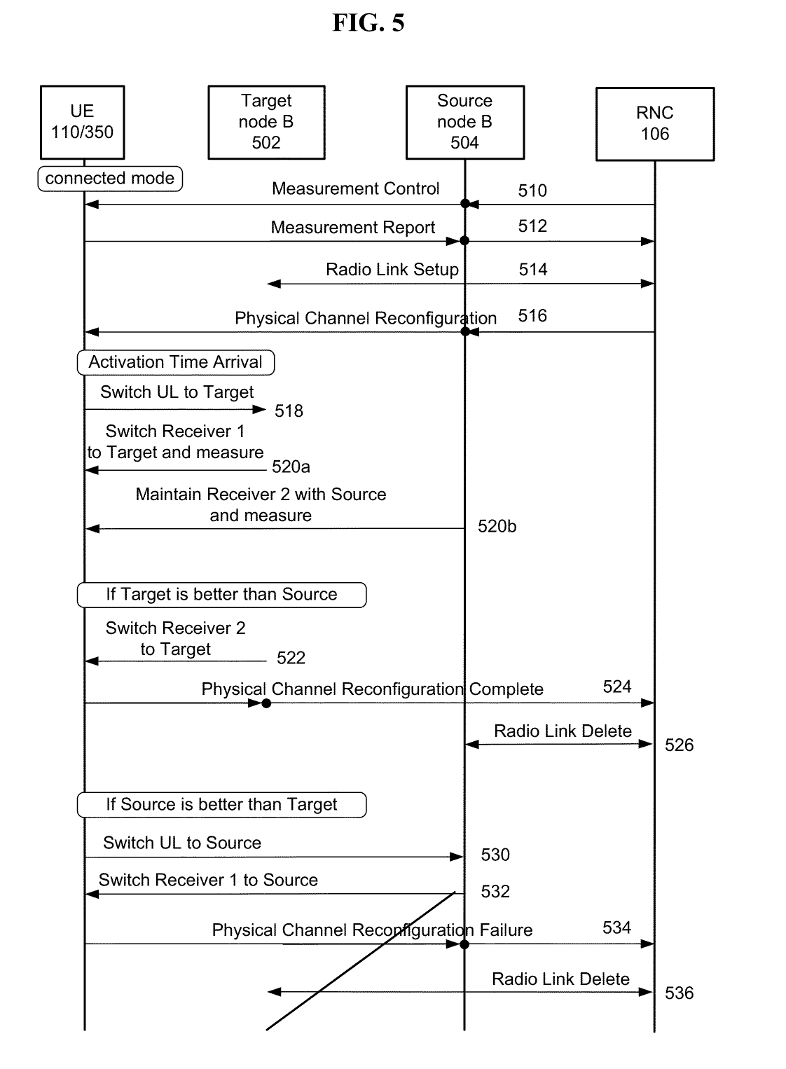

FIG. 5 illustrates a call-flow according to one aspect of the present disclosure. The UE 350 begins the call in connected mode with the source node B 504. During the call the RNC 106 initiates a measurement control message 510 to be sent to the UE 350 through the source node B 504. In response to the measurement control message 510, the UE measures neighboring potential target cells and reports those measurements in a measurement report 512 to the source node B which is sent to the RNC 106. Based on the measurements obtained by the UE, the RNC then determines that target node B 502 should be the target cell for the UE during handover The RNC and target node B 502 then perform a radio link setup exchange 514. The RNC then initiates a physical channel reconfiguration (i.e., handover) message 516 to be sent to the UE through the source node B 504. The physical channel reconfiguration message includes the identity of the target node B as well as the activation time.

Upon arrival of the activation time, the UE 350 commences baton handover. The UE 350 first switches its UL to connect to the target node B 502, as indicated in line 518. The UE 350 then switches a first receiver to the target node B 502 and measures the signal received from the target, as indicated in line 520a. At the same time, the UE 350 maintains a second receiver with the source node B 504 and measures the signal received from the source, as indicated in line 520b.

If the signal received at the UE 350 from the target node B 502 is of better quality than the signal received at the UE 350 from the source node B 504, the UE 350 switches the second receiver to the target node B 502 and sends a physical channel reconfiguration (i.e., handover) complete message to the RNC 106 through the target node B 502. The RNC and source node B 504 then complete a radio link delete exchange 526 for communications of the UE 350, thereby completing the handover.

If the signal received at the UE 350 from the target node B 502 is of lesser quality than the signal received at the UE 350 from the source node B 504, the UE 350 switches its uplink back to the source node B 504, as indicated in line 530. The UE 350 also switches receiver 1 back to the source node B 504, as indicated in line 532. The UE then sends a physical channel reconfiguration failure message 534 to the RNC 106 through the source node B 504. The RNC 106 and target node B 502 then complete a radio link delete exchange 536 for communications of the UE 350, thereby terminating the handover.

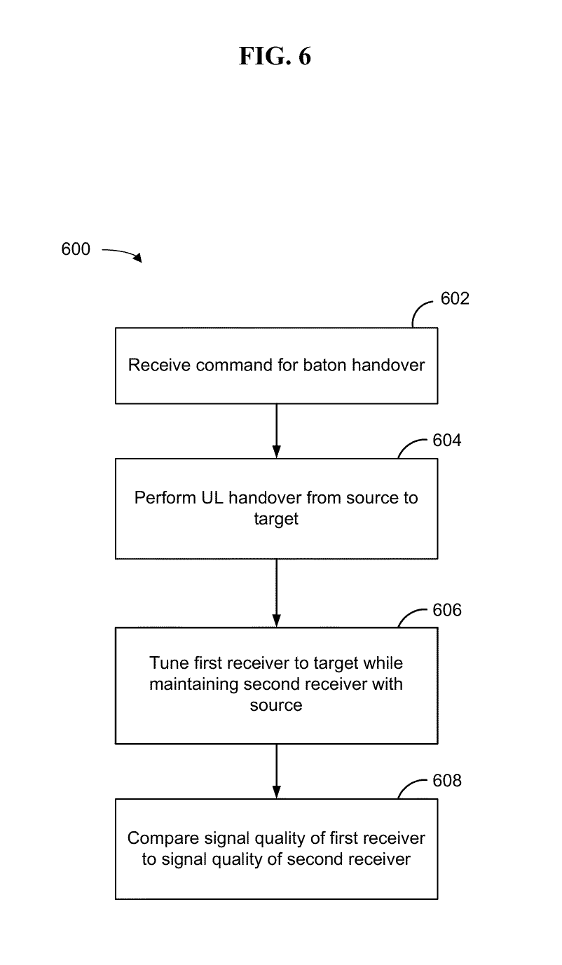

FIG. 6 shows an example of a wireless communication method 600 that may be used by the controller/processor 390 of the UE 110/350 during baton handover. A UE receives a command to perform a baton handover from a source cell to a target cell, as shown in block 602. The UE also performs a handover of uplink communications from the source cell to the target cell, as shown in block 604. The UE also tunes a first receiver to a working frequency of the target cell while maintaining a second receiver with a working frequency of the source cell, as shown in block 606. The working frequency of the target cell may be the same or different from the working frequency of the source cell. The UE then compares a first signal quality measured by the first receiver with a second signal quality measured by the second receiver, as shown in block 608.

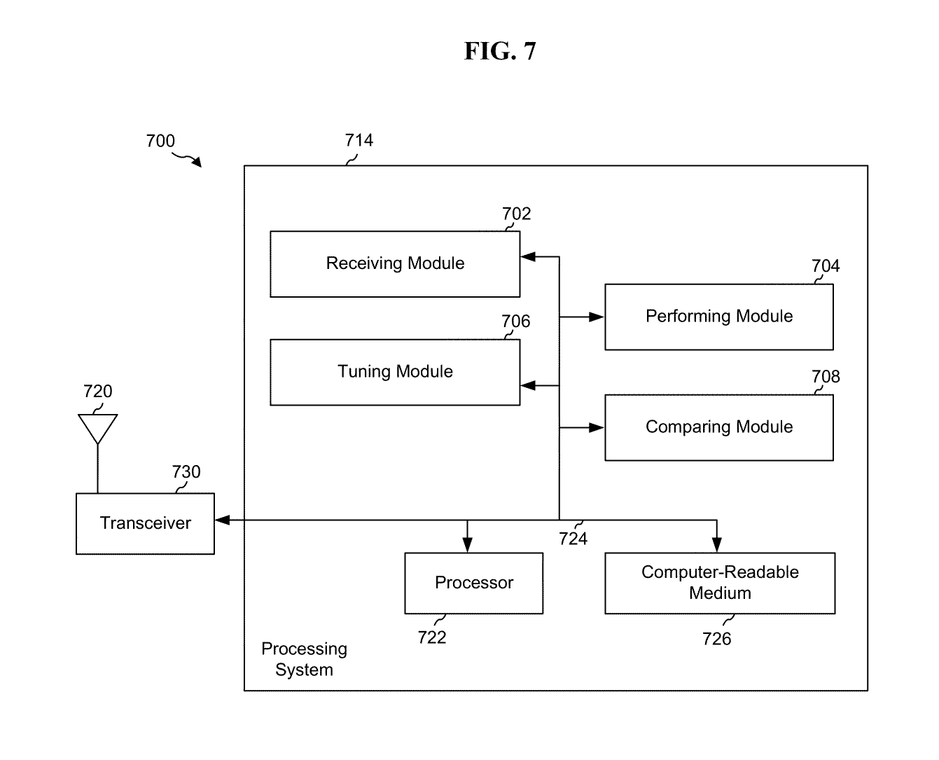

FIG. 7 is a diagram illustrating an example of a hardware implementation for an apparatus 700 employing a processing system 714. The processing system 714 may be implemented with a bus architecture, represented generally by the bus 724. The bus 724 may include any number of interconnecting buses and bridges depending on the specific application of the processing system 714 and the overall design constraints. The bus 724 links together various circuits including one or more processors and/or hardware modules, represented by the processor 722 the modules 702-708, and the non-transitory computer-readable medium 726. The bus 724 may also link various other circuits such as timing sources, peripherals, voltage regulators, and power management circuits, which are well known in the art, and therefore, will not be described any further.

The apparatus includes a processing system 714 coupled to a transceiver 730. The transceiver 730 is coupled to one or more antennas 720. The transceiver 730 enables communicating with various other apparatus over a transmission medium. The processing system 714 includes a processor 722 coupled to a non-transitory computer-readable medium 726. The processor 722 is responsible for general processing, including the execution of software stored on the computer-readable medium 726. The software, when executed by the processor 722, causes the processing system 714 to perform the various functions described for any particular apparatus. The computer-readable medium 726 may also be used for storing data that is manipulated by the processor 722 when executing software.

The processing system 714 includes a receiving module 702 for receiving a command to perform a baton handover from a source cell to a target cell. The processing system 714 includes a performing module 704 for performing a handover of uplink communications from the source cell to the target cell. The processing system 714 includes a tuning module 706 for tuning a first receiver to a working frequency of the target cell while maintaining a second receiver with a working frequency of the source cell. The processing system 714 includes a comparing module 708 for comparing a first signal quality measured by the first receiver with a second signal quality measured by the second receiver. The modules may be software modules running in the processor 722, resident/stored in the computer readable medium 726, one or more hardware modules coupled to the processor 722, or some combination thereof. The processing system 614 may be a component of the UE 110 and may include the memory 392, and/or the controller/processor 390.

In one configuration, an apparatus such as a UE 110/350 is configured for wireless communication including means for receiving. In one aspect, the receiving means may be the antennas 352, the receiver 354, the channel processor 394, the receive frame processor 360, the receive processor 370, the controller/processor 390, the memory 392, baton handover module 391, receiving module 702, and/or the processing system 714 configured to perform the receiving means.

The UE is also configured to include means for performing handover. In one aspect, the means may be the antennas 352, the receiver 354, the transmitter 356, the controller/processor 390, the memory 392, baton handover module 391, performing module 704 and/or the processing system 714 configured to perform the means. In one aspect the means functions recited by the aforementioned means. In another aspect, the aforementioned means may be a module or any apparatus configured to perform the functions recited by the aforementioned means.

The UE is also configured to include means for tuning. In one aspect, the tuning means may be the antennas 352, the receiver 354, the receive frame processor 360, the receive processor 370, the controller/processor 390, the memory 392, baton handover module 391, tuning module 706, and/or the processing system 714 configured to perform the tuning means. In one aspect the means functions recited by the aforementioned means. In another aspect, the aforementioned means may be a module or any apparatus configured to perform the functions recited by the aforementioned means.

The UE is also configured to include means for comparing. In one aspect, the comparing means may be the controller/processor 390, the memory 392, baton handover module 391, comparing module 708, and/or the processing system 714 configured to perform the comparing means. In one aspect the means functions recited by the aforementioned means. In another aspect, the aforementioned means may be a module or any apparatus configured to perform the functions recited by the aforementioned means.

Several aspects of a telecommunications system has been presented with reference to 3GPP in general, and to TD-SCDMA in particular. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for wireless communication, comprising:
receiving a command to perform a baton handover from a source cell to a target cell;
performing a handover of uplink communications from the source cell to the target cell;
tuning a first downlink receiver to a working frequency of the target cell while maintaining a second downlink receiver with a working frequency of the source cell; and
comparing a first signal quality measured by the first receiver with a second signal quality measured by the second receiver.

2. The method of claim 1, further comprising completing the baton handover by tuning the second receiver to the target cell when the first downlink receiver signal quality is greater than the second downlink receiver signal quality during a first predefined time duration.

3. The method of claim 2, in which the baton handover is completed at a time different from a baton handover uplink to downlink switch time.

4. The method of claim 1, in which the working frequency of the target cell is different from a primary frequency of the target cell.

5. The method of claim 1, in which the working frequency of the source cell is different from a primary frequency of the source cell.

6. The method of claim 1, in which the working frequency of the source cell is different from the working frequency of the target cell.

7. The method of claim 1, further comprising aborting the baton handover and staying on the source cell by tuning a transmitter from the target cell to the source cell and tuning the first receiver to the source cell when the second signal quality is greater than the first signal quality during a second predefined time duration.

8. An apparatus for wireless communication, comprising:
means for receiving a command to perform a baton handover from a source cell to a target cell;
means for performing a handover of uplink communications from the source cell to the target cell;
means for tuning a first downlink receiver to a working frequency of the target cell while maintaining a second downlink receiver with a working frequency of the source cell; and
means for comparing a first signal quality measured by the first receiver with a second signal quality measured by the second receiver.

9. The apparatus of claim 8, further comprising means for completing the baton handover by tuning the second receiver to the target cell when the first downlink receiver signal quality is greater than the second downlink receiver signal quality during a first predefined time duration.

10. The apparatus of claim 8, further comprising means for aborting the baton handover and staying on the source cell by tuning a transmitter from the target cell to the source cell and tuning the first receiver to the source cell when the second signal quality is greater than the first signal quality during a second predefined time duration.

11. A computer program product for wireless communication in a wireless network, comprising:
a computer-readable medium having non-transitory program code recorded thereon, the program code comprising:
program code to receive a command to perform a baton handover from a source cell to a target cell;
program code to perform a handover of uplink communications from the source cell to the target cell;
program code to tune a first downlink receiver to a working frequency of the target cell while maintaining a second downlink receiver with a working frequency of the source cell; and
program code to compare a first signal quality measured by the first receiver with a second signal quality measured by the second receiver.

12. The computer program product of claim 11, further comprising program code to complete the baton handover by tuning the second receiver to the target cell when the first downlink receiver signal quality is greater than the second downlink receiver signal quality during a first predefined time duration.

13. The computer program product of claim 11, further comprising program code to abort the baton handover and stay on the source cell by tuning a transmitter from the target cell to the source cell and tuning the first receiver to the source cell when the second signal quality is greater than the first signal quality during a second predefined time duration.

14. An apparatus for wireless communication, comprising:
a memory; and
at least one processor coupled to the memory and configured:
to receive a command to perform a baton handover from a source cell to a target cell;
to perform a handover of uplink communications from the source cell to the target cell;
to tune a first downlink receiver to a working frequency of the target cell while maintaining a second downlink receiver with a working frequency of the source cell; and
to compare a first signal quality measured by the first receiver with a second signal quality measured by the second receiver.

15. The apparatus of claim 14, in which the processor is further configured to complete the baton handover by tuning the second receiver to the target cell when the first downlink receiver signal quality is greater than the second downlink receiver signal quality during a first predefined time duration.

16. The apparatus of claim 15, in which the baton handover is completed at a time different from a baton handover uplink to downlink switch time.

17. The apparatus of claim 14, in which the working frequency of the target cell is different from a primary frequency of the target cell.

18. The apparatus of claim 14, in which the working frequency of the source cell is different from a primary frequency of the source cell.

19. The apparatus of claim 14, in which the working frequency of the source cell is different from the working frequency of the target cell.

20. The apparatus of claim 14, in which the processor is further configured to abort the baton handover and stay on the source cell by tuning a transmitter from the target cell to the source cell and tuning the first receiver to the source cell when the second signal quality is greater than the first signal quality during a second predefined time duration.
